(19) United States
(12) Patent Application Publication
(10) Pub. No.: US 2012/0221390 A1
(43) Pub. Date: Aug. 30, 2012

(54) REAL ESTATE REWARDS PROGRAM AND METHODS OF IMPLEMENTING SAME

(76) Inventor: Kevin Codey, Hoboken, NJ (US)

(21) Appl. No.: 13/406,587

(22) Filed: Feb. 28, 2012

Related U.S. Application Data
(60) Provisional application No. 61/447,135, filed on Feb. 28, 2011.

(51) Int. Cl. G06Q 30/02

(52) U.S. Cl. 705/14.17

(57) ABSTRACT

Implementing an incentive-based real estate program generally comprises: enabling a user to establish a user account on a network, the user account comprising data stored on a memory in a database at a remote server; enabling a real estate agent to establish a real estate agent account, the real estate agent account comprising data stored in the database; collecting real estate data from the user, the real estate data comprising user-specific interests in at least one real property, and storing the real estate data in the database; using a processor within the remote server to match the real estate data from the user with the real estate agent; monitoring a successful real estate transaction via data uploads from at least one of the user or the real estate agent; and providing credits to the user account, the credits holding a virtual currency value for redemption at a third party retailer.

### CROSS-REFERENCE TO RELATED APPLICATIONS

The present application claims priority to U.S. Provisional Application Ser. No. 61/447,135, entitled “Real Estate Rewards Program and Methods of Implementing Same,” filed Feb. 28, 2011, the disclosure of which is incorporated herein by reference in its entirety.

### BACKGROUND

1. Field of the Invention

Embodiments of the present invention are generally related to a real-estate rewards program and methods thereof. More specifically, embodiments of the present invention relate to a method and system for increasing a consumer's rebate through an incentive rewards program for buyers and sellers of residential and commercial property.

2. Description of the Related Art

Most real estate agents, brokers, authorized representatives, etc. are paid on a commission-based system, whereby a pre-determined percentage of a sales amount of a real estate transaction is paid to the representative for his or her efforts in completing the transaction. In many instances, the pre-determined percentage is established by law, rule, or local industry-standard (i.e., a regionally accepted breakdown of percentages). Depending on the number of persons involved, the percentages may fluctuate or be shared amongst several representatives of one party to the real estate transaction. In nearly all commission instances, however, every authorized representative shares one thing in common; the higher the value of a real estate transaction, the more compensation the authorized representative may receive from the transaction.

Under some regional and state laws, authorized representatives are able to return to their clients (i.e., a party to a real estate transaction) a portion of their commission in the form of cash or check, as a means to draw new clientele to them. While there may be no limitations on the amount that the authorized representative may remit back to the client, the authorized representative may find it difficult to find a balance between providing sufficient incentive and earning a living—that is, the more the authorized representative gives away, the less he or she earns.

In addition, in down markets, being a real estate agent can be quite difficult as landing quality and/or successful transactions are more rare than normal. As such, most real estate agents look for a way to distinguish and separate themselves from their peers. Often, through marketing, such distinction can be made, but at a very high cost which may cause an increase in problems due to no guarantee of results.

Thus, there is a need for an improved real estate rewards program and methods of implementing the same.

### SUMMARY

Embodiments of the present invention are generally related to a real-estate rewards program and methods thereof. More specifically, embodiments of the present invention relate to a method and system for increasing a consumer's rebate through an incentive rewards program for buyers and sellers of residential and commercial property.

In one embodiment of the present invention, a method of implementing an incentive-based real estate program comprises: enabling a user to establish a user account on a network, the user account comprising data stored on a memory in a database at a remote server; enabling a real estate agent to establish a real estate agent account, the real estate agent account comprising data stored in the database; collecting real estate data from the user, the real estate data comprising user-specific interests in at least one real property, and storing the real estate data in the database; using a processor within the remote server to match the real estate data from the user with the real estate agent; monitoring a successful real estate transaction via data uploads from at least one of the user or the real estate agent; and providing credits to the user account, the credits holding a virtual currency value for redemption at a third party retailer.

In another embodiment of the present invention, a system for implementing a real estate rewards program comprises: a server, accessible via a global computer network comprising a tangible computer readable medium comprising program instructions, wherein the program instructions are computer-executable to implement: enabling a user to establish a user account on a network, the user account comprising data stored on a memory in a database at a remote server; enabling a real estate agent to establish a real estate agent account, the real estate agent account comprising data stored in the database; collecting real estate data from the user, the real estate data comprising user-specific interests in at least one real property, and storing the real estate data in the database; using a processor within the remote server to match the real estate data from the user with the real estate agent; monitoring a successful real estate transaction via data uploads from at least one of the user or the real estate agent; and providing credits to the user account, the credits holding a virtual currency value for redemption at a third party retailer

In yet another embodiment of the present invention, a method of implementing an incentive-based real estate program comprises: enabling a user to establish a user account on a network, the user account comprising data stored on a memory in a database at a remote server; enabling a real estate agent to establish a real estate agent account, the real estate agent account comprising data stored in the database; collecting real estate data from the user, the real estate data comprising user-specific interests in at least one real property, and storing the real estate data in the database; monitoring a successful real estate transaction via data uploads from at least one of the user or the real estate agent; receiving, from the real estate agent, a reward fee equal to a pre-established percentage of a collected commission from the successful real estate transaction; and providing credits to the user account, the quantity of credits equivalent to a pre-established percentage of the reward fee, whereby the credits are redeemable at a third party retailer.

### BRIEF DESCRIPTION OF THE DRAWINGS

So the manner in which the above-recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a schematic of a system for a real estate rewards program in accordance with one embodiment of the present invention;

FIG. 2 depicts a block diagram of a general computer system, capable of being utilized in connection with the system depicted in FIG. 1, in accordance with another embodiment of the present invention;

FIG. 3 depicts a system level diagram for communication between a user and an administrator in accordance with one embodiment of the present invention;

FIG. 4 depicts a method of implementing a real estate rewards program in accordance with another embodiment of the present invention; and

FIG. 5 depicts an alternative method implementing a real estate rewards program in accordance with yet another embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, components and circuits have not been described in detail, so as to not obscure the following description. Further, the examples disclosed herein are for exemplary purposes only and other examples may be employed in lieu of, or in combination with, the examples disclosed. It should also be noted that the examples presented herein should not be construed as limiting of the scope of embodiments of the present invention, as other equally effective examples are possible and likely.

Embodiments of the present invention are generally related to a real-estate rewards program and methods thereof. More specifically, embodiments of the present invention relate to a method and system for increasing a consumer's rebate through an incentive rewards program for buyers and sellers of residential and commercial property.

As used herein, the terms “authorized representative,” “representative,” “agent,” “broker,” or the like, should be understood to generally include any person, persons, business or organization that facilitates or assists a person, business or organization in the acquisition, disposal, purchase, sale, lease, rental or other possessing-changing transaction involving real property—primarily, a form of real estate. Such terms may be interchanged in many instances without departing from the scope and intent of embodiments of the present invention. Although the following description may identify a few specific embodiments, it should be understood that various expansive embodiments of the present invention will become apparent to those of ordinary skill in the art upon understanding of these described embodiments of the present invention.

Also, as used herein, the term “multimedia data,” or just “data,” refers to any type of data that may reasonably be construed as a media data type, including specifically, audio data (e.g., sound bites, music, or the like), visual data (e.g., photographs, graphics, videos, or the like), text data (e.g., as entered by a user from an input device), barcode data (e.g., as commonly found on labels, receipts or the like), radio frequency identification (RFID) data, geographic and/or directional data (e.g., as reported from a Global Positioning System (GPS) or a preprogrammed routing source, often in the form of coordinates, or relationship positioning), or the like. As understood by the embodiments disclosed herein, any discussion of one particular form of multimedia data should be considered inclusive of any other type of data suitable for such embodiments.

As used herein, “credit(s)” may comprise any form of valuable credit issued by an administrator that may be deemed for rewards at any rewards partners, as described herein. In many embodiments, the credit is defined as a predetermined percentage of a representative's commission for assisting in and/or facilitating a real estate transaction, taking any plausible form in accordance with embodiments of the present invention. In other embodiments, a credit may be defined as a fixed amount per transaction. In yet further embodiments, a credit may be defined linearly, for example, equivalent to a value of a real estate transaction. The form of a credit may take any form suitable for embodiments of the present invention. For example, a credit may take the form of monetary compensation, a set of valued “points” redeemable within the system, value certificates redeemable within the system, or the like.

As also used herein, “reward(s)” may comprise a reward partner-specific currency (i.e., a tender having value solely to a specific retailer), a discount, or some other form of reward partner-specific value. Such rewards may take the form of coupons, discount certificates, gift cards, credit cards, or the like. In other embodiments, such rewards may be electronic, such that they may be redeemed through a computer-based system (e.g., website) operated by a reward partners. Generally, the rewards may be redeemed for goods or services offered by the reward partners. In many embodiments, the fair market value of the rewards are greater than the fair market value of the credit (i.e., by utilizing embodiments of the present invention, an increased value is realized at the reward partners).

In accordance with certain embodiments of the present invention, methods disclosed herein may occur in “real-time.” Real-time is utilized herein as meaning near-instantaneous, subject to minor delays caused by network transmission and computer processing functions, and able to support various input and output data streams.

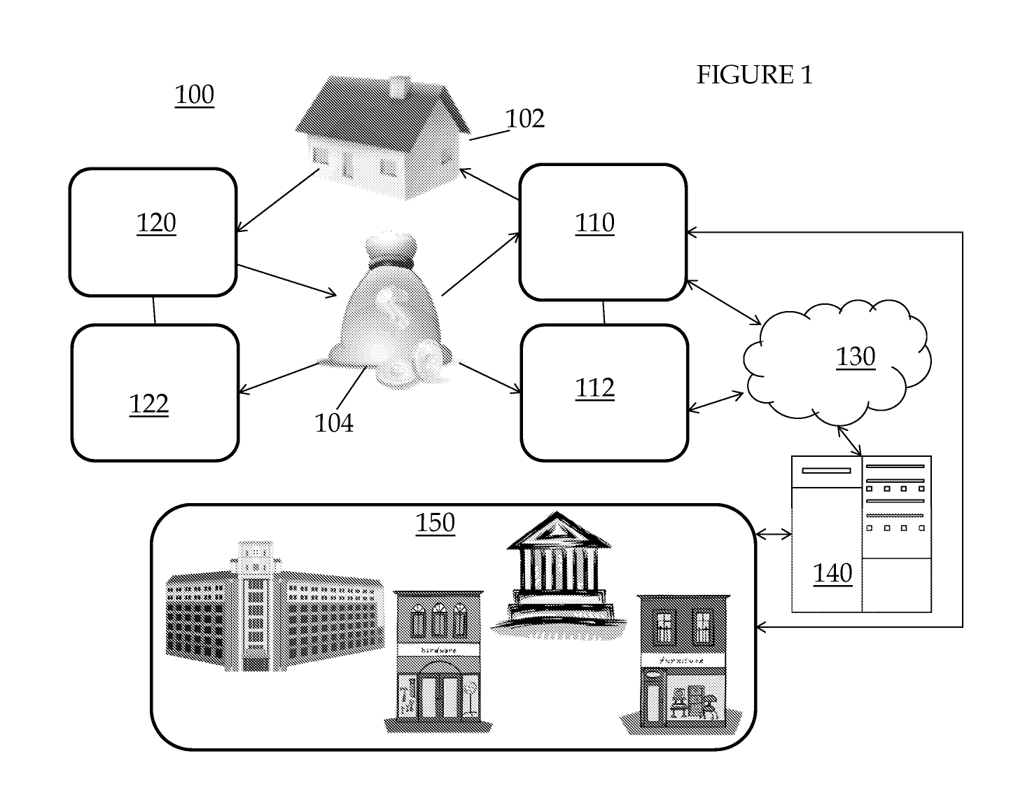

FIG. 1 depicts a schematic of a system for a real estate rewards program in accordance with one embodiment of the present invention. As shown in the Figure, the system 100 generally comprises real property 102 sought to be bought, sold, or otherwise transferred in ownership or possession, either permanently or for a limited period, in exchange for some form of monetary compensation 104. Such monetary compensation 104 may comprise cash (e.g., monies in the form of currency, check, credit, etc.), security (e.g., a lien, mortgage, etc.), or any other form of recognizable and valued compensation.

Depending on the nature of the real property 102, the transaction will generally include at least one seller 110 and one buyer 120, although numerous buyers or sellers may be included within the system 100 without departing from the nature and scope of embodiments of the present invention. The seller 110 and buyer 120 may comprise any person, business or organization capable of entering into a transaction involving real property. For many embodiments, the seller 110 and buyer 120 comprise individuals seeking to transfer ownership of real property, such as land, with or without a building, house or structure thereon.

In many instances, the buyer 120 and seller 110 are represented by at least one authorized representative, for example, buyer's representative 122 and seller's representative 112. As discussed supra, the authorized representative may include a real estate agent or agency, a real estate broker or brokerage house, co-broker or other similar person having an interest in at least one party to the real estate transaction.

In some embodiments, the buyer's representative 122 and/ or the seller's representative 112 may comprise a tiered structure of authorized representatives. For example, in many residential real estate transactions, the buyer's representative 122 may comprise a real estate agent actively engaged with the buyer 120, and a real estate agency, for whom the agent is listed, who may also likely receive compensation when the real estate transaction is completed. As such, it should be appreciated that embodiments of the present invention may include any number of representatives in a tiered structure, and the methods disclosed herein may be implemented by any or all of such representatives.

In the exemplary embodiment depicted, the seller 110 and seller's representative 112 may participate in the system 100 and methods that may operate therein. Although only the seller 110 and seller's representative 112 are participating in the disclosed example, those of ordinary skill in the art would appreciate the system 100 and methods may be extended to any number of parties described above. As such, in many embodiments, both the seller 112 and seller's representative may be in communication via a network 130, in which the methods of embodiments of the present invention are operable. In one embodiment, the network 130 may be a network internal to the seller's representative and may be a combination of any form of communication including face-to-face interactions, telephone discussions, email, postal mail, or the like.

In other embodiments, however, the network 130 may be a partial or full deployment of most any communication/computer network or link, including any of, any multiple of, any combination of or any combination of multiples of a public or private, terrestrial wireless or satellite, and wireline networks or links. The network 130 may include, for example, network elements from a Public Switch Telephone Network (“PSTN”), the Internet, core and proprietary public networks, wireless voice and packet-data networks, such as 1G, 2G, 2.5G, 3G and 4G telecommunication networks, wireless office telephone systems (“WOTS”) and/or wireless local area networks (“WLANs”), including, Bluetooth and/or IEEE 802.11 WLANs, wireless personal area networks (“WPANs”), wireless metropolitan area networks (“WMANs”) and the like; and/or communication links, such as Universal Serial Bus (“USB”) links; parallel port links, Firewire links, RS-232 links, RS-485 links, Controller-Area Network (“CAN”) links, and the like.

Where the network 130 comprises a computer-based network, such as many of those listed surpa, all parties described herein may be understood as comprising any form of electronic communication device, such as a general purpose, a portable computer, a handheld computer; a mobile phone, a digital assistant, a personal digital assistant, a cellular phone, a smart phone, a pager, a digital tablet, a laptop computer, an Internet appliance or the like. In many embodiments, however, a variety of network types may be implemented to achieve the goals of embodiments of the present invention.

Generally, an administrator 140 is also in communication with the seller 110 and seller's representative 112 through the network 130. For embodiments of the present invention, the administrator 140 may comprise any type of system management entity for overseeing and implementing the methods disclosed herein. In one embodiment, the administrator 140 is the same entity as the seller's representative—that is, in such an embodiment the seller's representative 112 also acts as the administrator 140 of the system 100. In another embodiment, the administrator 140 is an outside party to the transaction, available to implement the systems and methods disclosed herein.

Often, the nature of operation of the administrator 140 depends upon the nature of the network 130. For example, where the network 130 comprises a computer-based network, the administrator 140 may comprise a network-accessible server, or similar type of computer (e.g., as listed supra), having a database for storing records regarding parties and transactions as described herein. In another example, where the network 130 incorporates a physical proximity and/or face-to-face meetings between the parties, the administrator may comprise a local computer device, for acquiring and processing data regarding the parties and transactions as described herein. In a further example, where the seller's representative 112 is the administrator 140, the administrator 140 may comprise the seller's representative's computer, and may acquire and process data regarding the parties and transactions as described herein.

Embodiments of the present invention may also generally comprise one or more reward partners (collectively identified as 150). The reward partners 150 may comprise any merchant, retailer, vendor, or the like. In some embodiments, each of the reward partners comprise a retail store (e.g., home furnishing stores, home repair stores, grocery stores, pharmacies, etc.), local retail service provider (e.g., a restaurant, contractor, painter, etc.), a global retailer selling the products of others through an online-based store (e.g., Amazon, etc.), a computer-based service company (e.g., Travelocity, commercial airliners, etc), any combination of the above, or similar alternatives.

In many embodiments, each of the rewards partners 150 is in communication with the administrator 140. In some embodiments, the communication may take place through the network 130. For example, in one embodiment, the rewards partners 150 and the administrator 140 may be in communication via computer-based server-client transmissions, whereby data regarding a credit (as described infra) for the seller may be transmitted between the administrator and the rewards partners. In another exemplary embodiment, the rewards partners 150 may be indirectly in communication with the administrator 140 through credits issued by the administrator 140 and in possession of the seller 110, suitable for redemption for rewards at the rewards partners 150.

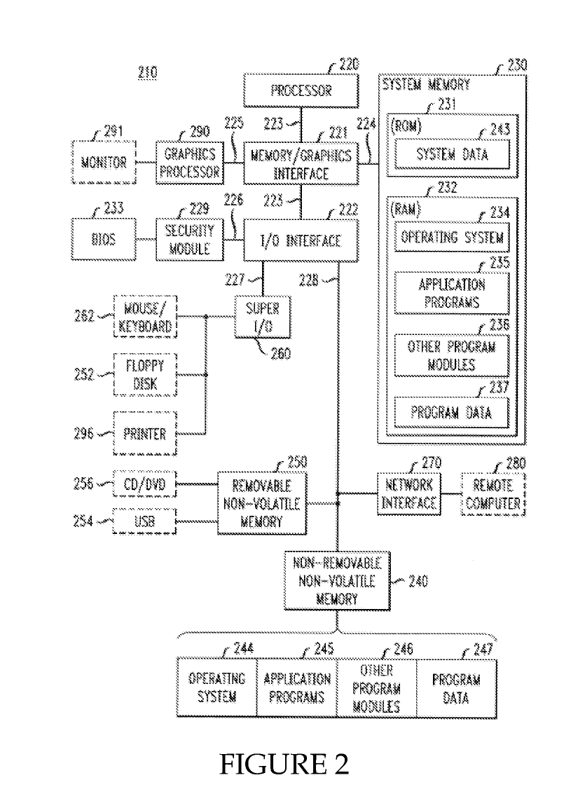

In accordance with one embodiment of the present invention, any of the administrator, buyer, seller, real estate agents, retailers, etc., may comprise a general purpose computer, for example, as shown in the form of a computer 210 depicted in FIG. 2, to assist in implementing various embodiments of the present invention. As appreciated by embodiments of the present invention, more practical devices, such as mobile devices, mobile telephones, or the like, are likely to be utilized than a general computer 210 for embodiments of the present invention. However, it is also appreciated there is a significant similarly in core components between a mobile device and a general computer 210. The following components are described for exemplary purposes only, and each component's mobile equivalent is also contemplated within embodiments of the present invention.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up.

In some embodiments, a security module 229 may be incorporated to manage metering, billing, and enforcement of policies. The security module 229 may comprise any known security technology suitable for embodiments disclosed herein.

A super input/output chip 260 may be used to connect to a number of “legacy” peripherals, such as floppy disk 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present invention, it should be appreciated, a multitude of similar computing devices exist and are equally suitable for embodiments of the present invention. It is further understood by embodiments of the present invention, a computing device may comprise all of the elements disclosed in FIG. 2, or any combination of one or more of such elements, in order to perform the necessary functions of the embodiments of the present invention.

It is understood by embodiments of the present invention that a computer, such as the one depicted in FIG. 2, may be connected to a computer network or system. A computer network includes the Internet, a global computer network, an internal computer network, dedicated server networks, and the like.

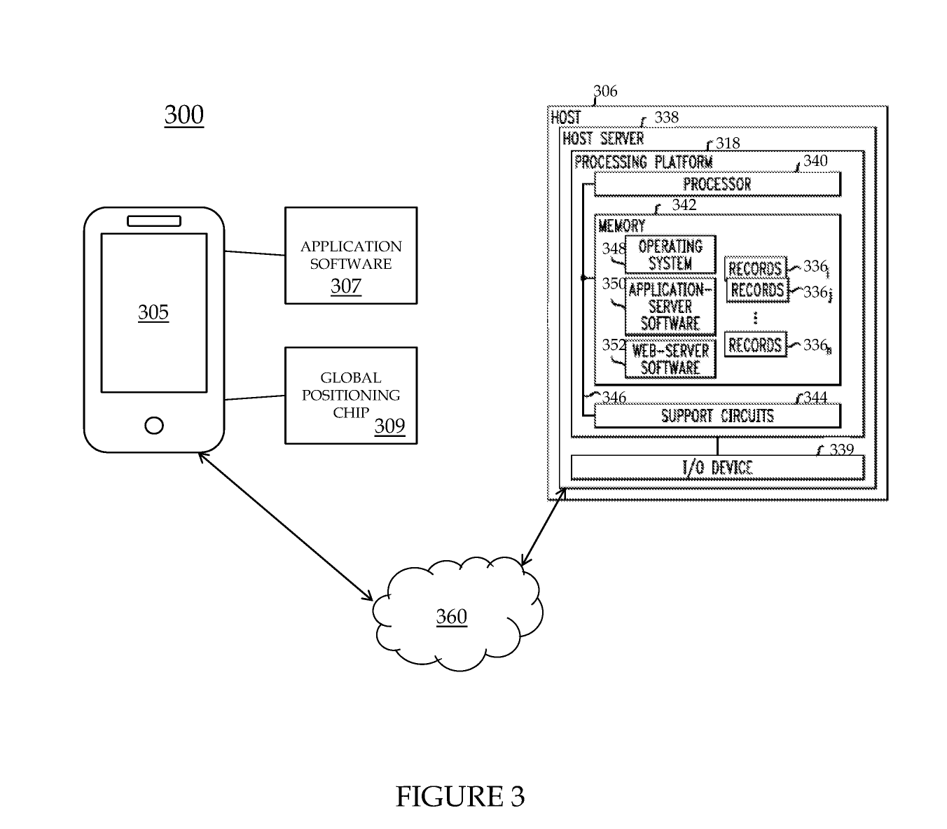

FIG. 3 depicts a system of communication between a user (e.g., a buyer/seller) and an administrator in accordance with one embodiment of the present invention. As shown in the Figure, a user 305 generally comprises a computer device, for example, a mobile phone or a smart phone, although any computer device, as described above, may be utilized. On the mobile device, the user 305 may also comprise application software 307 having instructions to execute any number of variations of embodiments of the present invention, and optionally, other common mobile device features, such as a global positioning chip 309. Other I/O components, which are common to computer devices, mobile phones and smart phones may also be provided but are not described in detail herein as they are well known in the industry.

Generally, the application software 307 is operable to interact through the network 360 with the administrator or host 306 to allow the user to engage in the functionality as disclosed herein. Generally, the application software 307 may be obtained from any source, for example, through a third party website or application. In one specific example, the third party application for allowing the user 305 to download the application software 307 may be the application made commercially by Apple, Inc., under its “iTunes” trademark. Other similar means of obtaining the application software 307 are readily known in the industry.

In alternative embodiments, the application software 307 may be stored by the administrator and accessed through the network 360 when used by the user 305. For example, the application software 307 may be available as streaming information, whereby a web browser (not shown) or similar program is utilized to communicate with the administrator 306 and engage in the functionality disclosed herein.

The user 305 may also comprise a global positioning chip 309 and accompanying software, to enable the administrator to obtain an accurate physical location of the user, or at least the user's computer device, when requested. The location information obtained through the global positioning chip 309, through a global positioning system (not shown), may be transmitted to the administrator 306 to facilitate certain functions of the system described herein. For example, as described herein, certain features, such as a local real estate agent search, or a local property search, may be enhanced by utilization of pinpoint locations based upon GPS data.

The network 360 may be similar to the network 160 as shown in FIG. 1 above, and may comprise any type of computer network or data network suitable for embodiments of the present invention.

The administrator or host 306 may include one or more servers, including a host server 338. The host server 338 may be deployed in one or more general or specialty purpose computers, personal computers, mainframes, minicomputers, server-type computers, such as the general purpose computer shown in FIG. 2, and/or any a processor-based platform that operates on any suitable operating system, such as Microsoft® Windows® and/or Linux; and that is capable of executing software.

The host server 338 may include a large number of elements; most of which are not shown in FIG. 3 for simplicity of exposition. The elements of host server 338 may be formed in a single unitary device and concentrated on a single server, client, peer or other type node. Alternatively, the elements of the host server 338 may be formed from two or more separate devices, and as such, may be distributed among a number of server, client, peer or other type nodes.

The host server 338 may be deployed in accordance with the scale-up and/or scale-out approaches. Using the scale-up approach, the host server 338 may increase its processing power, amount of memory and number of networkable connections by utilizing a symmetrical, multi-processor architecture so as to provide additional capacity. A benefit of this scale-up approach is that such approach provides for simplified configuration and management as compared to the scale-out approach. Using the scale-out approach, the host server 338 may increase its processing power, amount of memory and number of networkable connections by incrementally adding and/or removing capacity as needed, balancing workload across multiple processors, multiple servers, dedicating specific processors and/or servers for performing specific tasks, using physical or logical servers (e.g., a multi-node cluster approach), etc.

As shown, the host server 338 includes one or more processing units (collectively “processor”) 340, memory 342, supports circuits 344 and bus 346. The processor 340 may be one or more conventional processors, microprocessors, multi-core processors, microcontrollers and the like. In many embodiments, the processor 340 processes instructions, data and the like, with regard to executing various features within embodiments of the present invention.

The bus 346 provides for transmissions of digital information among the processor 340, memory 342 and support circuits 344 and other (not shown) portions of the host server 338. The support circuits 344 facilitate operation of the processor 340, and may include well-known circuitry or circuits, including, for example, one or more input/output I/O interfaces, one or more NIUs, cache; clock circuits, power supplies or the like.

The I/O interface provides an interface to control the transmissions of digital information among (shown and not shown) components of host server 338. In addition, the I/O interface provides an interface to control the transmissions of digital information among I/O devices 339 associated with or otherwise attached to the host server 138. The I/O devices 339 may be embodied as any or any combination of (i) storage devices, including but not limited to, a tape drive, a floppy drive, a hard disk drive or a compact disk drive, (ii) a receiver, (ii) a transmitter, (iii) a speaker, (iv) a display, (v) a speech synthesizer, (vi) an output port, and (vii) a pointing device, such as a mouse, joystick, trackball, touchpad, pointing stick, light pen, head pointer, soap mouse, eye tracking devices, digitizing tablet and stylus, data glove that translates the user's movements to computer gestures; (vii) a key-in device, such as a keyboard or a touchpad, (viii) and the like.

The NIUs facilitate exchange (e.g., sending and/or receiving) of content and/or data. Accordingly, the NIUs may be adapted for communicating over terrestrial wireless, satellite, and/or wireline media.

The memory 342 may be or employ random access memory, read-only memory, optical storage, magnetic storage, removable storage, erasable programmable read only memory and variations thereof, content addressable memory and variations thereof, flash memory, disk drive storage, removable storage, any combination thereof, and the like. The memory 324 may store and/or receive requests from the processor 340 to execute various software packages, such as operating system 348, application-server software 350 and web-server software 352.

Additionally, the memory 342 may store and/or receive requests from the processor 340 to obtain the records 336i-336n (e.g., copies thereof). As above, each of the records 136i-136n may be stored as or in a single file or a plurality of files, and may be structured as text, a table, a database, a distributed hashtable, a distributed concurrent object store, a document formed using a markup or markup-like language, and the like. The records 136i-136n may be stored, for example, using a Microsoft SQL Server and accessible through an ODBC connection.

Like the records 336i-336n, the memory 342 may store and/or receive requests from the processor 340 to obtain operands, operators, dimensional values, configurations, and other data that are used by the various software packages to control the operation of and/or to facilitate performing the functions of the host server 338 and/or the host 306.

The application-server software 350, when executed by the processor 340, is operable to communicate with the user 305, and often the application software 307, via the network 360, to obtain the information regarding the user 305 (e.g., buyer/seller), the real estate broker (not shown), the opposing party to a transaction (not shown), a third party retailer (not shown, or the like, and store it as record 336j. The application-server software also facilitates the features of the system as described herein based on the information stored in record 336j associated with the user 305. In addition, the application-server software 350, when executed by the processor 340, is operable to enable interaction between the users within a virtual set group as described herein.

The web-server software 352, which may be optional, when executed by the processor 340, is operable provide on one or more network or web-accessible pages to allow the user 305 to access information stored on the host server 338. For example, web-server software 352 may provide a data portal, having a graphical user interface, through which a user 305 may access the application-server software 350 and the functionality thereof. In such an embodiment, the application software 307 of the user 305 may only comprise a web browser or similar application for viewing the content of the web-server software 352 through the network 360.

It should be appreciated by embodiments of the present invention, although only one user 305 is shown, other users may access the administrator 306 in a similar fashion, such that a plurality of users can co-exist in communication with the administrator 306 through the network 360.

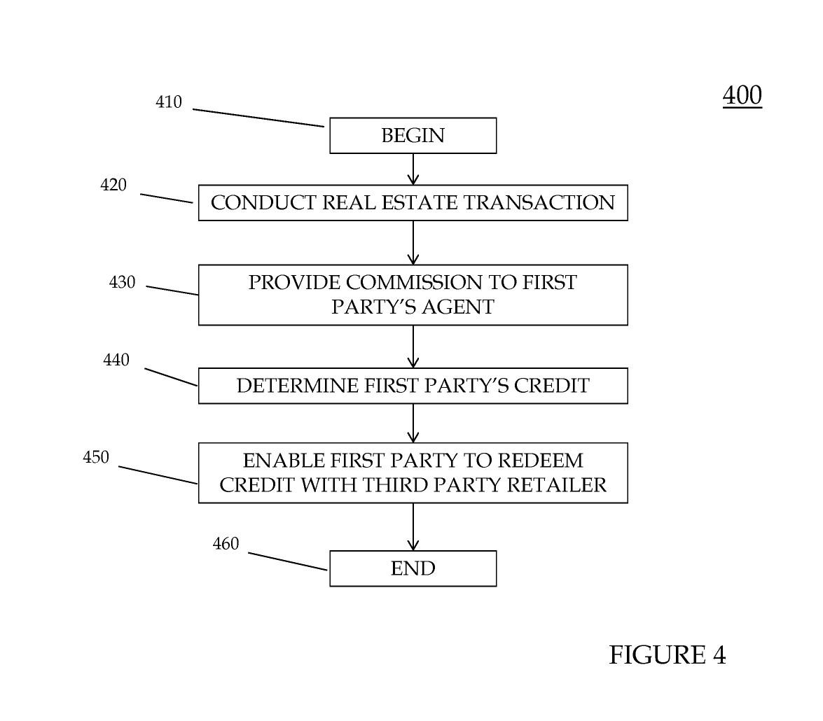

FIG. 4 depicts a method of implementing a real estate rewards program in accordance with another embodiment of the present invention. The method 400 is described for one specific exemplary embodiment, and should not be deemed limiting for any purpose. The method 400 may be implemented within any system suitable for embodiments of the present invention, for example, the system described above with regard to FIG. 1.

The method 400 begins at step 410. At step 420, a real estate transaction is completed. Such real estate transaction may comprise any type of residential or commercial real estate transaction, for example, those listed supra. For the exemplary embodiment described, the real estate transaction comprises the sale of a residential property having a single family home thereon, between a first party (buyer) and a second party (seller). In such an embodiment, both the buyer and seller are represented by respective real estate agents. As understood by those of ordinary skill in the art, such real estate agents generally assist their clients with finding a buyer/seller and/or property that compliments their client's needs, and facilitate the offers, counteroffers, and acceptance of real estate transactions.

For the present example, focusing on the buyer of the residential property, the buyer's agent may be working on a contingent basis, whereby the buyer's agent receives a commission only when the buyer actually closes a real estate transaction and acquires a property. In many embodiments, the commission paid to the buyer's agent is pre-determined before any negotiations over a specific property takes place. For example, the commission for the buyer's agent may be set at a low percentage (e.g., three percent), a tiered percentage (e.g., three percent up to $250,000, two percent between $250,000 and $500,000, and one percent for everything thereover), a combined percentage and cap (e.g., three percent, capped at $15,000 regardless of the sales price), or the like.

At step 430, after the real estate transaction has been completed, and a sales price has been agreed to between the parties and paid by the buyer, the buyer's agent may receive a payment equivalent to the pre-determined amount as discussed supra. Generally, the payment is made via check, cash, electronic funds transfer (EFT), or similarly accepted form of payment from a real estate transaction. For example, assuming a three percent (3%) commission was pre-determined between the buyer and buyer's agent, and the sales price of the real estate transaction was $100,000, the buyer's agent would receive $3,000 from the real estate transaction.

In addition to setting a pre-determined commission, in accordance with embodiments of the present invention, the buyer's agent may promote the reward system as disclosed herein, and notifying prospective clients (i.e., potential buyers and sellers) that a pre-determined percentage of the buyer's agent's commission will be remitted to the prospective client in the form of credits within the reward system. For example, in one embodiment, the buyer's agent may offer its client (i.e., the buyer) one-third of its commission in the form of credits.

At step 440, a credit may be provided to the buyer to be redeemed at a participating reward partner, the value of the credit being equal to the value based upon the pre-determined percentage of the buyer's agent's commission. Where a one-third agreement was reached, and the buyer's agent's commission was $3,000 based on 3% of a $100,000 sales price, the credit would be valued at $1,000.

As discussed supra, the credit may be provided in any form suitable for embodiments of the present invention. In many embodiments, the credit may in the form of monetary compensation, a set of valued “points” redeemable within the system, or value certificates redeemable within the system. Generally, the processing of the credit to the buyer occurs through the administrator. For example, where the administrator is a third party, the administrator may issue credits through an account directly to the buyer, and collect the pre-determined percentage of the buyer's agent's commission. In another example, where the administrator is the buyer's agent, the processing of the credit may occur directly from the buyer's agent to the buyer.

At step 450, the buyer may redeem the credit at a reward partner for a reward. The nature of the redemption of the credit is often dependent upon the nature of the credit. For example, where by the credit is in the form of points redeemable in the system, the administrator may generally be hosting a network-accessible website, wherein the buyer may be able to log into an account where the credits are stored. In such an embodiment, the credits may then be redeemable through a rewards system (e.g., as used by American Express, WorldPoints, etc.), whereby the reward partners have an established relationship between credit-value and reward value. In the example above, the credit may be in the form of 1,000 credits, redeemable through a network-accessible rewards system. Once the buyer is logged into the account, the buyer may be able to utilize 1,000 credits for $1,200 worth of merchandise through one of the reward partners—realizing a 20% increase in value.

In another example, where the credit is in the form of monetary compensation, the buyer may also be able to select with which reward partner the credit should be redeemed. Once selected, the buyer may be presented with a certificate good for a 20% discount for shopping with the reward partner. In certain embodiments, the buyer may also be required to spend at least the value of the credit in order to realize the 20% discount.

In yet another example, the credit may be provided in the form of a monetary value, which may be redeemed with the reward partner of the buyer's choice, presented in the physical form of a gift card or gift certificate. Similar to the examples described above, rather than provide a credit for dollar exchange, a gift card may be worth a certain percentage over the credit value, such that the buyer may realize the benefit of utilizing embodiments of the present invention.

The method 400 ends at step 460.

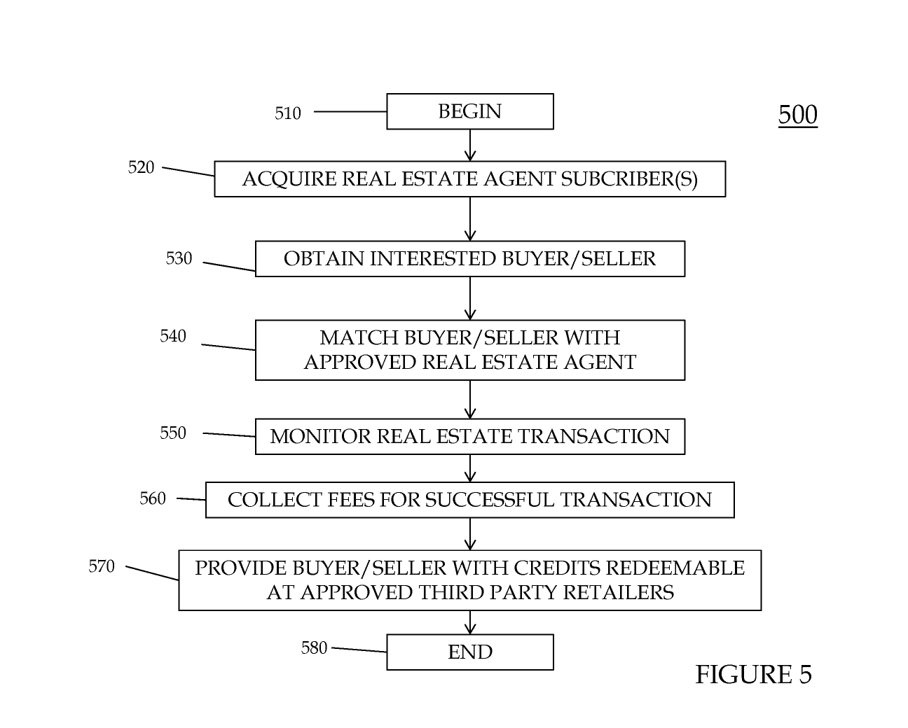

In an alternative embodiment of the present invention, the system(s) described herein may be utilized in a similar and related manner to achieve an alternative method of implementing a real estate rewards program. FIG. 5 depicts one such alternative method 500.

The method 500 begins at step 510. At step 520, the administrator may obtain, acquire and/or appoint one or more authorized real estate agents to work within the system. In many embodiments, the administrator may receive an application from a real estate agent who wishes to be affiliated with the system, with such application containing the necessary information to make an informed decision on whether such real estate agent would be suitable for embodiments of the present invention. In one embodiment, such application may be done electronically through an interface with the administrator via the network. In other embodiments, however, the administrator may seek out particular real estate agents in a particular location, having a particular skill set, or the like.

In some embodiments, the administrator may designate a single real estate agent or team of real estate agents to a particular market (e.g., town, county, association—such as a condo association, commercial/residential, or the like). In such an embodiment, the administrator may be selective over which real estate agent is chosen for each market. It may be desirable, in certain markets, to allow a particular real estate agent to have exclusivity within the system, such that the administrator does not appoint any additional real estate agents within the same market to avoid direct competition within the system.

In many embodiments, once the real estate agent has been acquired, appointed, etc., the administrator may require detailed information regarding the real estate agent's business (e.g., volume, inventory, etc.). In addition, in certain embodiments, in order to become part of the system, the real estate agent may have to pay a membership fee. Such membership fee may be a one-time fixed fee up front, a recurring monthly fee, or a performance fee, such that a fee is only paid when the system has financially benefited the real estate agent. It should be noted that alternative embodiments of the present invention may use any other type of generally known subscription system, and in one particular embodiment, the real estate agents do not pay any type of dues or subscription fee.

At step 530, the administrator collects information regarding a person or entity interesting in buying, renting, leasing, selling, or otherwise transferring rights in real property. In an exemplary embodiment, a person interested in buying a home may enter requested data through the administrator's website and/or application. Such data may include what the person is looking for in a home, the number of bedrooms, bathrooms and existence of other features or structures. Similarly, in another exemplary embodiment, if a seller is trying to sell a home, the seller may describe details regarding their ownership of the home, the desired sale price, etc.

In some embodiments, in order to engage the functionality of the system, the buyer/seller may have to create a user account within the database at the administrator. Such user account may store the person's information on the administrator's database for later use, for example, when issuing credits.

Once information is obtained regarding the buyer/seller, and real estate agents have been appointed within the system, the administrator matches the buyer/seller with an appropriate real estate agent who handles the market which may be most highly matched with the needs of the buyer/seller. For example, if a home buyer is looking to move to a particular town, the administrator may match the buyer with a real estate agent from the particular town. Similarly, if a home seller is selling a home in a very upscale suburban neighborhood frequently known for attracting professionals working in a nearby metropolitan area, the administrator may match the seller with a real estate agent who specializes in helping such types of people relocate to the suburbs.

Once the parties are matched, the progression of ordinary research, look, offer, counter-offer, etc., between a buyer/seller and the real estate agent is not too out of line with the ordinary methods of doing so. However, in some embodiments, throughout the entire process, the administrator may be monitoring the ongoing potential transactions. At step 550, when a successful real estate transaction is entered (i.e., the seller is selling, the buyer is buying, or the like), the administrator monitors the specific details of the transaction, and in particular, the purchase price of the property bought or sold.

Optionally, at step 560, the administrator may be entitled to collect a fee as a broker of the transaction, having made the introduction between buyer/seller and the real estate agent. In many embodiments, such fee is a percentage of the overall purchase price of the real estate transaction. In other embodiments, the fee is a flat fee for having productively introduced the parties which led to a successful transaction. Such fee may be taken directly from the purchase contract (e.g., via a clause in the contract that such fee is to be paid at closing), from the real estate agent(s) once their fees have cleared and/or within a set time frame from closing date, or the like.

At step 570, the buyer/ seller is provided with credits as a result of having successfully completed a real estate transaction via the system. Similar to method 400, the determination of quantity of credits may vary from embodiment to embodiment. In one embodiment, the quantity of credits provided to the buyer/seller may be calculated through a linear calculation based upon purchase price of the real estate transaction. For example, in one embodiment, the buyer/seller may be provided with one credit for each dollar of the purchase price. In another example, the system may provide that over certain thresholds, credits are worth more or less—e.g., a 10% increase in quantity of credits for every $100,000 over a $300,000 purchase price. In yet alternative embodiments, any of the other means of determining credit quantity may be suitable.

Once the credits are calculated, they are given to the buyer/seller for use with third party retailers. In many embodiments, when the buyer/seller is given credits, they may be in the form of points or otherwise virtual currency, usable through a particular virtual retail store. Generally, in such an embodiment, the credits would be provided as data to be stored within the buyer/seller's user account within the system. In other embodiments, any of the calculation, distribution, or redemption methods described above with regard to FIG. 4, may be suitable for these embodiments of the present invention as well. The method 500 ends at step 580.

In further embodiments of the present invention, the systems described herein may be provided with various features currently available in social networking sites. For example, in some embodiments, the systems herein may be accessible through a common social networking site, such as FaceBook, Google+, or the like, as an application therein. In other embodiments, when looking up homes or real estate online in a web browser through common home/real estate sites, a user may be able to bookmark, tag, or pin any properties they find interesting, and such bookmark, tag or pin would automatically be linked with their account within the system. Embodiments of the present invention appreciate that other similar variations of common social networking features, as known in the industry, may also be utilized.

Although a variety of embodiments have been disclosed herein, certain details regarding the structure and processing of various computer systems and network-accessible point-based reward systems have been left out of this description as they are commonly known in the industry. As such, the present disclosure is intended to set forth the novel and unique features of embodiments of the present invention, but should not be deemed limited hereto, and should incorporate knowledge readily available to those of ordinary skill in the art for enablement purposes.

While the foregoing is directed to embodiments of the present invention, other and further embodiments of the invention may be devised without departing from the basic scope thereof. It is also understood that various embodiments described herein may be utilized in combination with any other embodiment described, without departing from the scope contained herein. In addition, embodiments of the present invention are further scalable to allow for additional clients and servers, as particular applications may require.

1. A method of implementing an incentive-based real estate program comprising:
enabling a user to establish a user account on a network, the user account comprising data stored on a memory in a database at a remote server;
enabling a real estate agent to establish a real estate agent account, the real estate agent account comprising data stored in the database;
collecting real estate data from the user, the real estate data comprising user-specific interests in at least one real property, and storing the real estate data in the database;
using a processor within the remote server to match the real estate data from the user with the real estate agent;
monitoring a successful real estate transaction via data uploads from at least one of the user or the real estate agent; and
providing credits to the user account, the credits holding a virtual currency value for redemption at a third party retailer.

2. The method of claim 1, wherein the real estate agent pays a subscription fee to establish the real estate agent account.

3. The method of claim 1, wherein a plurality of real estate agents are enabled to establish respective real estate agent accounts, and each real estate agent account is dedicated to a particular market.

4. The method of claim 1, wherein monitoring the successful real estate transaction comprising noting the final purchase price of the real estate transaction and recording the final purchase price in the user account.

5. The method of claim 1, further comprising:
using the processor to calculate a quantity of credits to provide to the user account as a function of a purchase price of the real estate transaction.

6. The method of claim 5, wherein calculating the quantity of credits includes a linear function with respect to the purchase price of the real estate transaction.

7. The method of claim 1, further comprising:
enabling the user to redeem the credits at the third party retailers via the network.

8. The method of claim 7, wherein redeeming the credits comprises shopping at a virtual forum where third party retailers accept credits as a form of valuable consideration.

9. A system for implementing a real estate rewards program comprising:
a server, accessible via a global computer network comprising a tangible computer readable medium comprising program instructions, wherein the program instructions are computer-executable to implement:
enabling a user to establish a user account on a network, the user account comprising data stored on a memory in a database at a remote server;
enabling a real estate agent to establish a real estate agent account, the real estate agent account comprising data stored in the database;
collecting real estate data from the user, the real estate data comprising user-specific interests in at least one real property, and storing the real estate data in the database;
using a processor within the remote server to match the real estate data from the user with the real estate agent;
monitoring a successful real estate transaction via data uploads from at least one of the user or the real estate agent; and
providing credits to the user account, the credits holding a virtual currency value for redemption at a third party retailer.

10. The system of claim 9, wherein the real estate agent pays a subscription fee to establish the real estate agent account.

11. The system of claim 9, wherein a plurality of real estate agents are enabled to establish respective real estate agent accounts, and each real estate agent account is dedicated to a particular market.

12. The system of claim 9, wherein monitoring the successful real estate transaction comprising noting the final purchase price of the real estate transaction and recording the final purchase price in the user account.

13. The system of claim 9, further comprising:
using the processor to calculate a quantity of credits to provide to the user account as a function of a purchase price of the real estate transaction.

14. The system of claim 13, wherein calculating the quantity of credits includes a linear function with respect to the purchase price of the real estate transaction.

15. The system of claim 9, further comprising:
enabling the user to redeem the credits at the third party retailers via the network.

16. The method of claim 15, wherein redeeming the credits comprises shopping at a virtual forum where third party retailers accept credits as a form of valuable consideration.

17. A method of implementing an incentive-based real estate program comprising:
enabling a user to establish a user account on a network, the user account comprising data stored on a memory in a database at a remote server;
enabling a real estate agent to establish a real estate agent account, the real estate agent account comprising data stored in the database;
collecting real estate data from the user, the real estate data comprising user-specific interests in at least one real property, and storing the real estate data in the database;
monitoring a successful real estate transaction via data uploads from at least one of the user or the real estate agent;
receiving, from the real estate agent, a reward fee equal to a pre-established percentage of a collected commission from the successful real estate transaction; and
providing credits to the user account, the quantity of credits equivalent to a pre-established percentage of the reward fee, whereby the credits are redeemable at a third party retailer.

18. The method of claim 17, wherein the credits comprise one of a coupon, a voucher, or a gift card.

19. The method of claim 17, wherein a plurality of real estate agents are enabled to establish respective real estate agent accounts, and each real estate agent account is dedicated to a particular market.

20. The method of claim 17, wherein the third party retailers comprise physical retail shops.
